(19) United States
(12) Patent Application Publication
(10) Pub. No.: US 2026/0109291 A1
(43) Pub. Date: Apr. 23, 2026

(54) SYSTEMS AND METHODS FOR PROVIDING TEMPORARY VEHICLE FEATURES, LIGHTS, AND SOUNDS USING A MOBILE DEVICE

(71) Applicant: Rivian IP Holdings, LLC, Irvine, CA (US)

(72) Inventors: Thomas Buck Sleeper, Mission Viejo, CA (US); Erik Robert Glaser, San Mateo, CA (US); Michael Adkins Knott, San Mateo, CA (US); Timmy Chau, Fremont, CA (US)

(21) Appl. No.: 19/363,154

(22) Filed: Oct. 20, 2025

Related U.S. Application Data
(60) Provisional application No. 63/709,368, filed on Oct. 18, 2024.

(51) Int. Cl. B60Q 3/74; B60K 35/10; B60K 35/81; B60Q 1/24; B60Q 3/85; H04R 5/04

(52) U.S. Cl. CPC B60Q 3/74; B60K 35/10; B60K 35/81; B60Q 1/247; B60Q 3/85; H04R 5/04; B60K 2360/122; B60K 2360/573; B60Q 2900/30; B60Q 2900/50; H04R 2499/13

(57) ABSTRACT

Systems, methods, and devices for providing temporary vehicle features, lights, and sounds using a mobile device are provided herein. The systems, methods, and devices include presenting, via a first user interface, a plurality of selectable vehicle themes. In response to receiving a user input identifying a selected vehicle theme from the plurality of selectable vehicle themes: activating an event mode, retrieving a plurality of theme parameters, wherein the plurality of theme parameters each correspond to the selected vehicle theme, and performing a plurality of vehicle functions based on the retrieved plurality of theme parameters. Additionally, the systems, methods, and devices include, in response to detecting a vehicle drive action while the event mode is active, deactivating the event mode.

### CROSS REFERENCE TO RELATED APPLICATION

This application claims priority to U.S. Provisional Patent Application No. 63/709,368, filed on Oct. 18, 2024, the entire contents of which are hereby expressly incorporated by reference herein in their entirety.

### INTRODUCTION

The present disclosure is directed to providing transient vehicle features, and, more particularly, to providing transient vehicle features of vehicle functions to enhance user experience.

### SUMMARY

As vehicles have become increasingly digitized, the number of options provided to a user to customize settings of different vehicle features and systems has also increased. For example, in one approach, a user may customize the display mode of a display provided in a vehicle by selecting the display mode from a menu (e.g., light mode or dark mode). However, depending on the number of customizations that are available, it may be burdensome for the user to find desired customizations. In another approach, certain vehicle features may be automatically changed based on detected environmental conditions. For example, the display may operate in a day mode or a night mode based on the detected ambient light. However, the variability of other features that are not dependent on detected environmental conditions may be limited. In accordance with the present disclosure, event mode time periods (e.g., themed-event periods) are used to provide transient vehicle features of vehicle functions to enhance user experience.

In accordance with the present disclosure, a method of performing themed vehicle functions is provided. The method includes presenting, via a first user interface, a plurality of selectable vehicle themes. The method also includes, in response to receiving a user input identifying a selected vehicle theme from the plurality of selectable vehicle themes: activating an event mode, retrieving a plurality of theme parameters, wherein the plurality of theme parameters each correspond to the selected vehicle theme, and performing a plurality of vehicle functions based on the retrieved plurality of theme parameters. The method further includes, in response to detecting a vehicle drive action while the event mode is active, deactivating the event mode.

In some embodiments, the method further includes determining a current time, and identifying the plurality of selectable vehicle themes based on the current time. For instance, if the current time is in late October, the plurality of selectable vehicle themes may include one or more Halloween or holiday-based themes.

In some embodiments, the method further includes determining a current vehicle location, and identifying the plurality of selectable vehicle themes based on the current vehicle location. For instance, if the current vehicle location is within a particular area (e.g., city), the plurality of selectable vehicle themes may include one or more local sports themes based on a sports team located in that city, or a location-specific holiday relevant to that city.

In some embodiments, one or more event mode features may remain available after the event mode has ended, while one or more other features revert to their normal operation. For example, the method may further include activating the event mode for a predetermined period of time, and in response to determining that the predetermined period of time has ended, deactivating the event mode, performing a first vehicle function based at least in part on a first theme parameter of the retrieved plurality of theme parameters, and performing a second vehicle function based at least in part on a first normal parameter of a retrieved plurality of normal parameters.

In some embodiments, presenting the plurality of selectable vehicle themes is based on determining that the vehicle is parked. That is, the vehicle may first determine the current vehicle gear and may enable presentation of the selectable vehicle themes only if the current vehicle gear is park.

In some embodiments, the first user interface comprises a mobile device communicatively coupled to the vehicle. The plurality of selectable vehicle themes may be presented via the mobile device, to enable a user to remotely select and activate or deactivate one a given theme. Additionally, in some embodiments, the method may further include modifying one or more of a volume, interior lighting, exterior lighting, or sound effect of the vehicle based on additional user input to the mobile device.

In some embodiments, detecting the vehicle drive action comprises detecting that the vehicle is no longer parked or detecting a brake pedal input.

In some embodiments, the plurality of vehicle functions corresponding to the selected vehicle theme comprises at least two of modifying an interior vehicle lighting color, modifying an exterior vehicle lighting color, modifying an interior vehicle audio, modifying an exterior vehicle audio, or modifying a vehicle display screen theme.

In some embodiments, the method further includes, in response to detecting the vehicle drive action while the event mode is active, temporarily deactivating the event mode. And in response to detecting that the vehicle drive action has ended, re-activating the event mode.

In some embodiments, a system is provided. The system includes a plurality of devices configured to perform a plurality of vehicle functions of a vehicle, and processing circuitry. The processing circuitry is configured to cause, via a first user interface, a plurality of selectable vehicle themes to be presented. The processing circuitry is also configured to, in response to receiving a first user input identifying a selected vehicle theme from the plurality of selectable vehicle themes: activate an event mode, retrieve a plurality of theme parameters, wherein the plurality of theme parameters each correspond to the selected vehicle theme, and control the plurality of devices to perform the plurality of vehicle functions based on the retrieved plurality of theme parameters. The processing circuitry is further configured to, in response to detecting a vehicle drive action while the event mode is active, deactivate the event mode.

In some embodiments, the processing circuitry is further configured to determine a current time and identify the plurality of selectable vehicle themes based on the current time.

In some embodiments, the processing circuitry is further configured to determine a current vehicle location, and identify the plurality of selectable vehicle themes based on the current vehicle location.

In some embodiments, one or more event mode features may remain available after the event mode has ended, while one or more other features revert to their normal operation. For example, the processing circuitry may be further configured to activate the event mode for a predetermined period of time. Then in response to determining that the predetermined period of time has ended, the processing circuitry may deactivate the event mode, control the plurality of devices to perform a first vehicle function based at least in part on a first theme parameter of the retrieved plurality of theme parameters, and control the plurality of devices to perform a second vehicle function based at least in part on a first normal parameter of a retrieved plurality of normal parameters.

In some embodiments, presenting the plurality of selectable vehicle themes is based on determining that the vehicle is parked. That is, the processing circuitry is further configured to present the plurality of selectable options based on determining that the vehicle is parked.

In some embodiments, the first user interface comprises a mobile device communicatively coupled to the vehicle. Additionally, the processing circuitry may be further configured to modify one or more of a volume, interior lighting, exterior lighting, or sound effect of the vehicle based on additional user input to the mobile device.

In some embodiments, the processing circuitry is further configured to detect the vehicle drive action by detecting that the vehicle is no longer parked or detecting a brake pedal input.

In some embodiments the plurality of vehicle functions comprises at least two of modifying an interior vehicle lighting color, modifying an exterior vehicle lighting color, modifying an interior vehicle audio, modifying an exterior vehicle audio, or modifying a vehicle display screen theme.

In some embodiments, the processing circuitry is further configured to, in response to detecting the vehicle drive action while the event mode is active, temporarily deactivate the event mode. And in response to detecting that the vehicle drive action has ended, re-activate the event mode.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows a block diagram of components of a system of a vehicle for providing transient vehicle features of vehicle functions, in accordance with some embodiments of the present disclosure;

FIG. 2 shows a block diagram of an illustrative control system comprising a plurality of domain controllers (e.g., modules) for controlling certain functions of a vehicle, in accordance with some embodiments of the present disclosure;

FIG. 3 shows an exemplary interface for enabling an event mode, in accordance with some embodiments of the present disclosure;

FIG. 4 shows an exemplary interface for enabling the Halloween event mode, in accordance with some embodiments of the present disclosure;

FIG. 5 shows an exemplary interface once the Halloween event mode is enabled, in accordance with some embodiments of the present disclosure;

FIG. 6 shows examples of other vehicle functions that are modified when the Halloween event mode is enabled, in accordance with some embodiments of the present disclosure;

FIGS. 7A-7C show examples of a default pedestrian icon and a zombie pedestrian icon that may be displayed during the respective modes, in accordance with some embodiments of the present disclosure;

FIGS. 8A and 8B show examples of default yeti icon and the Halloween yeti icon that may be displayed during the respective modes, in accordance with some embodiments of the present disclosure;

FIGS. 9A and 9B show examples of Halloween lock and unlock sounds and of default or normal lock and unlock sounds that may be played during the respective modes, in accordance with some embodiments of the present disclosure;

FIG. 10 shows a flowchart of an illustrative process for enabling an event mode during an event mode time period, in accordance with some embodiments of the present disclosure; and

FIG. 11 shows a flowchart of an illustrative process for performing a vehicle function based on the current vehicle parameters retrieval mode, in accordance with some embodiments of the present disclosure;

FIGS. 12A-B show a block diagram of an example system architecture, in accordance with some embodiments of the present disclosure;

FIG. 13 shows a sequence diagram for turning on a costume theme, in accordance with some embodiments of the present disclosure;

FIG. 14 shows another example sequence diagram, in accordance with some embodiments of the present disclosure;

FIG. 15 shows an example mobile device with a display enabling a selection of a costume theme, in accordance with some embodiments of the present disclosure;

FIG. 16 shows example dashboard, center console, and rear seat screen displays when a first costume theme is active, in accordance with some embodiments of the present disclosure;

FIG. 17 shows example dashboard, rear seat screen, and center console displays when a second costume theme is active, in accordance with some embodiments of the present disclosure;

FIG. 18 shows a flowchart of an example method, in accordance with some embodiments of the present disclosure;

FIG. 19 illustrates example exterior views of a vehicle, in accordance with some embodiments of the present disclosure; and

FIG. 20 illustrates a flowchart of an example method for performing themed vehicle functions, in accordance with some embodiments of the present disclosure.

### DETAILED DESCRIPTION

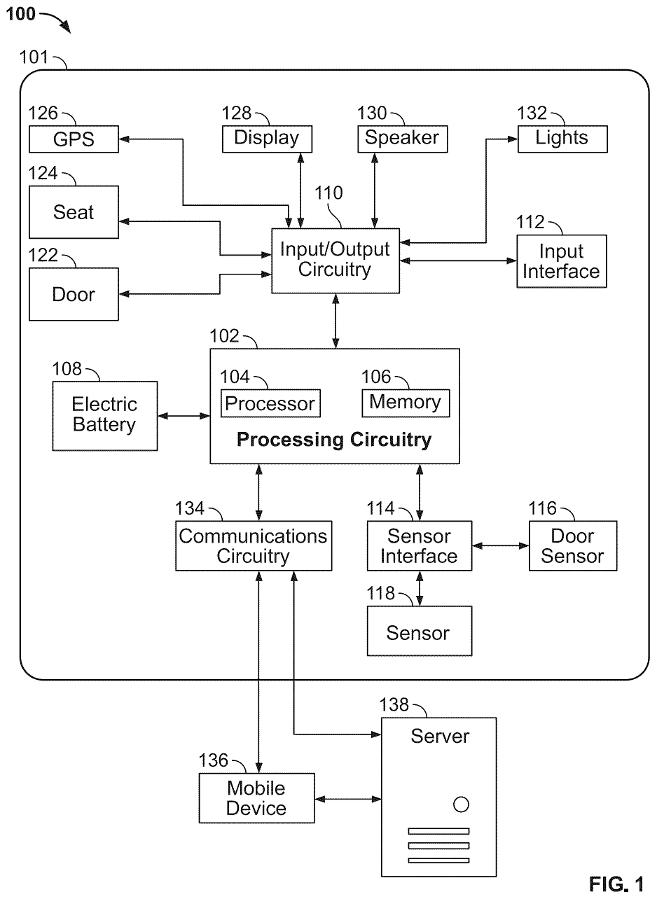

FIG. 1 shows a block diagram of components of a system 100 of vehicle 101 for providing transient vehicle features of vehicle functions, in accordance with some embodiments of the present disclosure. Vehicle 101 may be a car (e.g., a coupe, a sedan, a truck, an SUV, a bus), a motorcycle, an aircraft (e.g., a drone), a watercraft (e.g., a boat), or any other type of vehicle. Vehicle 101 may be an electric vehicle, internal combustion engine vehicle, hybrid vehicle, or any other type of vehicle.

Vehicle 101 may comprise processing circuitry 102, which may comprise processor 104 and memory 106. Processor 104 may comprise a hardware processor, a software processor (e.g., a processor emulated using a virtual machine), or any combination thereof. In some embodiments, processor 104 and memory 106 in combination may be referred to as processing circuitry 102 of vehicle 101. In some embodiments, processor 104 alone may be referred to as processing circuitry 102 of vehicle 101. In some embodiments, a combination of one or more of the mobile device 136, server 138, and/or processing circuitry 102 may be referred to as the processing circuitry of the vehicle 101. That is, in some embodiments processing circuitry may be distributed across the vehicle 101, mobile device 136, and/or server 138. Memory 106 may comprise hardware elements for non-transitory storage of commands or instructions, that, when executed by processor 104, cause processor 104 to operate vehicle 101 in accordance with embodiments described above and below. Processing circuitry 102 may be communicatively connected to components of vehicle 101 via one or more wires, or via wireless connection.

Processing circuitry 102 may be communicatively connected to electric battery 108, which may be configured to provide power to one or more of the components of vehicle 101 during operation. Sensor 118 (e.g., a camera, radar module, lidar module, or any suitable image sensor) may be communicatively coupled to processing circuitry 102 (e.g., by way of sensor interface 114) and positioned at any suitable position in an interior or exterior of vehicle 101. In some embodiments, sensor 118 may capture images of the area around vehicle 101 in real time to identify pedestrians, other vehicles, obstacles, lane markings, etc., which may be displayed on a navigation interface. In some embodiments, sensor 118 may capture images of destinations traveled to by vehicle 101 to identify the environment in which vehicle 101 is parked (e.g., an outdoor parking lot, an indoor parking lot, a garage, the number of nearby vehicles, etc.). Processing circuitry 102 may be communicatively connected to input interface 112 (e.g., a steering wheel, a touch screen display, buttons, knobs, a microphone or other audio capture device, etc.) via input/output circuitry 110. In some embodiments, a driver of vehicle 101 may be permitted to select certain settings in connection with the operation of vehicle 101 (e.g., passive entry settings). In some embodiments, processing circuitry 102 may be communicatively connected to Global Positioning System (GPS) system 126 of vehicle 101, where the driver may interact with the GPS system via input interface 112. GPS system 126 may be in communication with multiple satellites to ascertain the vehicle's location and provide navigation directions to processing circuitry 102. As another example, the positioning device may operate on terrestrial signals, such as cell phone signals, Wi-Fi signals, or ultra-wideband signals to determine a location of vehicle 101. The determined location may be in any suitable form such as a geographic coordinate, a street address, a nearby landmark such as an identification of the nearest charging station or a tagged location associated with the vehicle (e.g., a location of a home of the user stored in memory 106).

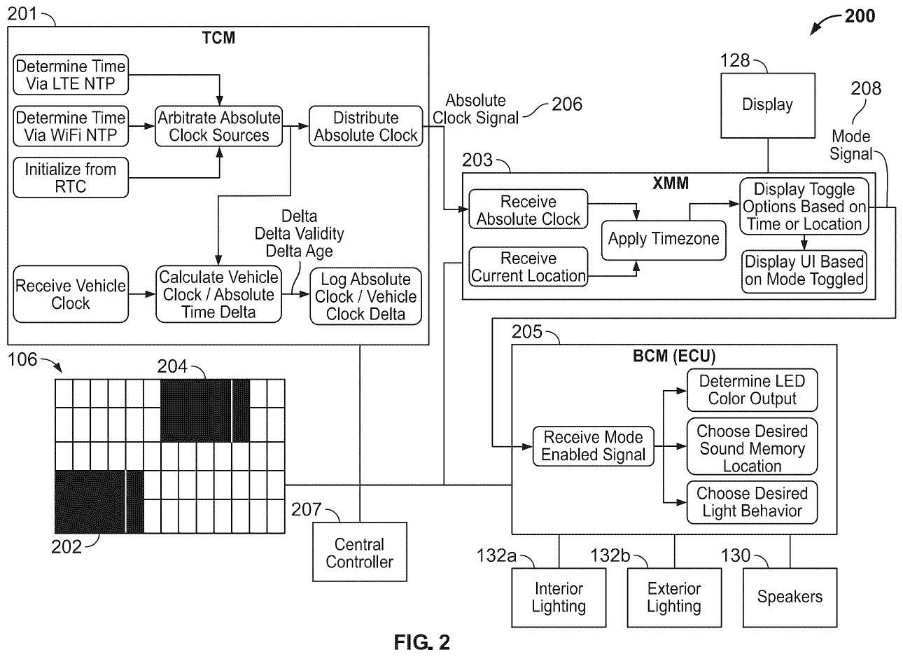

Processing circuitry 102 may be communicatively connected to door 122, seat 124, display 128, speaker 130, and lights 132, by way of input/output circuitry 110. In some embodiments, input/output circuitry 110 may comprise one or more domain controllers, as explained in further detail below with reference to FIG. 2. Display 128 may be located at a dashboard of vehicle 101 and/or a heads-up display on a windshield of vehicle 101. For example, an interface for GPS system 126 or an interface of an infotainment system may be generated for display, and display 128 may comprise an LCD display, an OLED display, an LED display, or any other type of display. In some embodiments, display 128 may provide a driver with a navigation interface, an entertainment interface, a backup camera interface, etc. In some embodiments, the navigation interface may generate, in real-time, a simplified rendering (e.g., animation) of objects around vehicle 101 that are captured by sensor 118 (e.g., people, other vehicles, lane markings, etc.). Speaker 130 may be located at any location within the cabin of vehicle 101, e.g., at the dashboard of vehicle 101, on an interior portion of the vehicle door. In some embodiments, speaker 130 may be located outside the cabin of vehicle 101 and provide audio that is audible outside of vehicle 101 (e.g., a personalized greeting during a welcome action of the vehicle, a door lock/unlock sound, etc.). Lights 132 may be interior or exterior lights that provide light from inside or outside of vehicle 101 (e.g., during a welcome action of the vehicle). Processing circuitry 102 may also be communicatively connected (e.g., by way of sensor interface 114) to door sensor 116 (e.g., which may sense an open door of vehicle 101).

Processing circuitry 102 may be in communication (e.g., via communications circuitry 134) with mobile device 136 (e.g., of the driver of vehicle 101). Mobile device 136 may be, for example, a smartphone, tablet, a camera, a camera array, a laptop computer, a personal computer, a desktop computer, a smart television, a smart watch or wearable device, smart glasses, extended reality (XR) glasses, XR goggles, an XR head-mounted display (HMD), near-eye display device, or any other suitable computing device or combination thereof. Such connection may be wired or wireless. In one example, such a connection is a two-way connection via the BLE standard (e.g., via a BLE transceiver). In some embodiments, communications circuitry 134 and/or mobile device 136 may be in communication with one or more servers 138 (e.g., over a communications network such as, for example, the Internet).

It should be appreciated that FIG. 1 only shows some of the components of vehicle 101, and it will be understood that vehicle 101 also includes other elements commonly found in vehicles (e.g., vehicles), e.g., a motor, brakes, wheels, wheel controls, turn signals, windows, doors, etc. Vehicle 101 may also include a plurality of domain controllers and a central controller for performing various vehicle functions (e.g., causing a plurality of selectable themes to be presented via a user interface such as the user interface of mobile device 136, activating or deactivating an event mode, retrieving one or more event mode parameters and/or normal mode parameters corresponding to event mode functions and/or normal mode functions, unlocking a door of vehicle 101, and playing an unlock sound in response to receiving an unlock command, for example), as explained in greater detail below with reference to FIGS. 2-19.

FIG. 2 shows a block diagram of illustrative control system 200 comprising a plurality of domain controllers (e.g., modules) for controlling certain functions of vehicle 101, in accordance with some embodiments of the present disclosure. The illustrative control system may correspond to certain elements illustrated in FIG. 1 (e.g., processing circuitry 102, sensor interface 114, input/output circuitry 110, etc.). In some embodiments, control system 200 may include a central gateway (e.g., central controller 207) along with other domain controllers for controlling certain other functions of vehicle 101. Control system 200 may implement an event modes application to provide transient vehicle features of certain vehicle functions during a predetermined time window (e.g., an event mode time period). That is, the events mode application may include one or more modifications to the vehicle function compared with a normal mode application (e.g., associated with a normal mode). In one approach, the provided transient vehicle features may be related to the predefined time period. For example, Halloween-themed vehicle features may be provided for a time period around Halloween. In some approaches, the event modes application may provide multiple selectable themes for an event that are selectable by a user. For instance, the event modes application may provide a set of three selectable themes for Halloween. The activation of one of those selectable themes may then cause one or more vehicle features to be modified (e.g., lighting, sound, displays, etc.). Some approaches may also disable the event mode when a drive action is taken, such as stepping on the brake pedal or changing the vehicle gear. In some embodiments, the events mode application may coordinate time-based, geo-based, and/or user-based alterations to default vehicle features, lights, and sounds. As shown, the domain controllers may include, e.g., telematics control module (TCM) 201, experience management module (XMM) 203, and body control module (BCM) 205. However, these are only some examples, and the domain controllers may include other suitable vehicle modules such an acoustic vehicle alert system (AVAS).

The plurality of domain controllers and the central gateway may be implemented (using software running on one or more general purpose or specialized processors (e.g., electronic control units (ECUs) or electronic control modules (ECMs)). For example, in one embodiment, as shown, control system 200 may be implemented by a plurality of devices (modules) and a plurality of software components. As shown, certain components of control system 200 may communicate over a communication network using any suitable protocol such as a local interconnect network (LIN) protocol, a C-Bus protocol, Ethernet, by internet communication, etc.

Central controller 207 and one or more of the plurality of domain controllers (e.g., TCM 201, XMM 203, and BCM 205) may implement different types of suitable functions for the operation of vehicle 101. For example, central controller 207 and one or more of the plurality of domain controllers implement sense functions (e.g., for monitoring or detecting a condition), compute functions (e.g., for computing an event mode or computing a value-based input from the sense functions), and act functions (e.g., to send a notification or command or broadcast an event mode, or to implement control). For example, as shown, BCM 205 may be implemented as a device (e.g., including an ECU) and may include a plurality of sense functions, including a door ajar status function and a door lock status function.

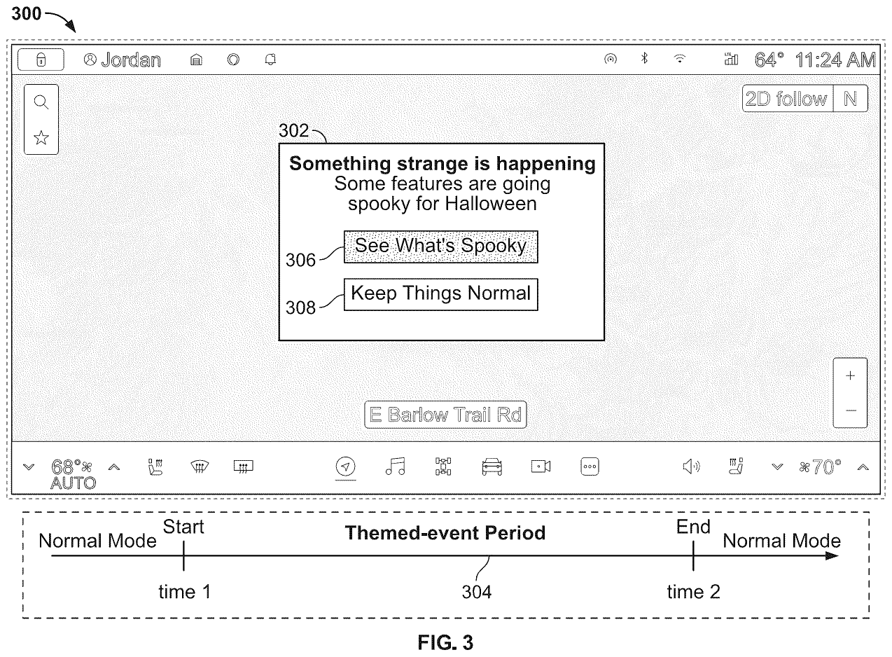

As shown, TCM 201 may determine the absolute time (e.g., Greenwich Mean Time). For example, TCM 201 may determine the absolute time based on data inputs, LTE, Wi-Fi or by any other suitable method (e.g., by executing sense functions). TCM 201 may also calculate vehicle clock/absolute time data based on the determined absolute time and a received vehicle clock. TCM 201 may implement an act function to log the absolute time and vehicle clock delta (e.g., in memory 106). TCM 201 may also communicate the determined absolute time to XMM 203 (e.g., by absolute clock signal 206), which may determine the local time zone (e.g., the current time) based on the current location of vehicle 101 (e.g., based on received GPS data or based on any other suitable method). If the current time is within a preset time period of an event mode stored in memory (e.g., memory 106), XMM 203 may generate for display (e.g., on display 128), a user option to enable the event mode, toggle a feature, or enable certain time-limited functionality, as shown in further detail with reference to FIG. 3. In some examples, the XMM may generate a plurality of selectable options (e.g., a plurality of selectable themes) that correspond to the event mode. In response to receiving a user confirmation to enable the event mode, and/or receiving a selection of one of the plurality of selectable themes, XMM 203 updates the event mode to enabled or active and sends a system signal to other domain controllers (e.g., ECU) to enable the event mode. For example, XMM 203 sends a system signal (e.g., mode signal 208) to BCM 205 indicating that the event mode is enabled. Based on the enabled event mode, the respective domain controllers modify features of vehicle functions based on the enabled event mode and/or the selected theme. For example, as shown, BCM 205 may determine an LED color output or a desired light behavior of interior lighting 132a or exterior lighting 132b of the vehicle or designate a memory location to retrieve sound to be played through speakers 130 (e.g., in response to certain events), based on the enabled event mode and/or the selected theme. That is, while the event mode is active during the event mode time period, BCM 205 may perform certain vehicle functions differently (e.g., with respect to a normal mode or a default mode), as explained in greater detail below. Once the event mode time period expires, and/or when a drive action is detected, the operation of BCM 205 and other domain controllers may automatically return to a normal or default mode. In some embodiments, each of the domain controllers associated with an event mode may set a vehicle parameters retrieval mode to the event mode when the event mode is active and revert the vehicle parameters retrieval mode to a normal mode when the event mode is no longer active. In some embodiments, the current vehicle parameters retrieval mode may control the parameters (e.g., settings, sounds, images, etc.) that are retrieved when certain vehicle functions are performed (e.g., in response to receiving a command to perform the vehicle function or in response to the vehicle function being called). For example, when the vehicle is locked (e.g., a lock command is received), different lock sounds may be retrieved based on the current setting of the vehicle parameters retrieval mode. In one example, first memory location 202 in memory 106 stores a first set of vehicle parameters (e.g., one or more first files) associated with an event mode and/or selected theme, and second memory location 204 in memory 106 stores a second set of vehicle parameters (e.g., one or more second files) associated with a normal mode. Some embodiments may also include a third (or subsequent) memory location in memory 106 that stores further sets of vehicle parameters that correspond to various themes. In some embodiments, each of the domain controllers may store one or more sets of vehicle parameters in a local memory. In some embodiments, memory 106 may reside in the central controller or may be distributed in one or more domain controllers. In some embodiments, memory 106 comprises a plurality of separate memory and the first set of vehicle parameters associated with an event mode (and/or first theme) may be stored in a first memory and a second set of vehicle parameters associated with a second theme or normal mode may be stored in a second memory different than the first memory. Additional memory may also be included, which may store further sets of vehicle parameters that may be associated with other themes or vehicle modes. In some embodiments, each of the multiple memories may have different access or security levels. For example, the second set of vehicle parameters may be stored in a memory or memory location that is more secure than a memory or memory location storing the second set of vehicle parameters. In some embodiments, one or more vehicle parameters may be retrieved from a server.

In some embodiments, XMM 203 may automatically enable an event mode at the start of the event mode time period, without displaying a prompt. For example, vehicle 101 may track a baseline of a user's past interactions with event modes and/or theme selection, store this information in a user profile, and make a determination of whether to automatically enable an upcoming event mode or prompt the user to enable the upcoming event mode (and/or select one of a plurality of available themes) based on the user profile. In some embodiments, XMM 203 may end an enabled event mode early, by determining dissatisfaction by the user with an event mode (e.g., by tracking changes in the baseline of the user's past interactions). The XMM 203 may also end an enabled event mode early by determining that a drive action has occurred, such as a brake pedal press or gear shift.

In some embodiments, XMM 203 may temporarily pause or disable an enabled event mode (e.g., based on safety conditions and vehicle state). For example, certain features of an event mode may only be available when vehicle 101 is not in motion (e.g., parked) or when traveling below a certain speed. Additionally, in some embodiments the initial transition into an event mode, and/or an automatic disabling of the event mode, may be available based on safety conditions or vehicle state. Examples of event modes are described in greater detail below with reference to FIGS. 3-19.

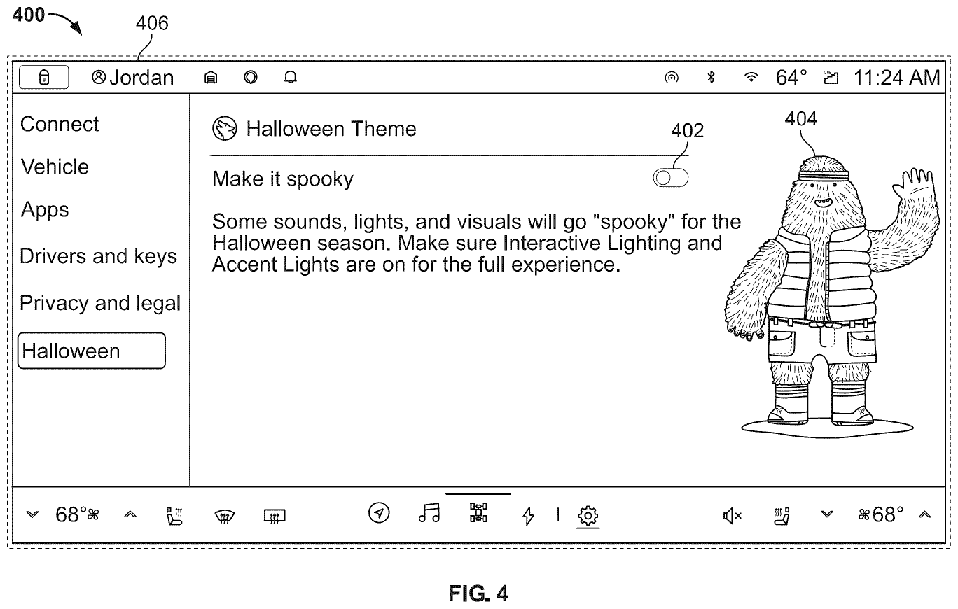

FIG. 3 shows an exemplary interface 300 for enabling an event mode, in accordance with some embodiments of the present disclosure. As shown, the event mode may be defined by themed-event period 304 beginning at time 1 and ending at time 2. In one example, the event mode may be a Halloween event mode having a themed-event period corresponding to the holiday of Halloween (e.g., beginning on Oct. 29, 2022, at 1 PM local time and ending on Nov. 1, 2022, 2 PM local time). Thus, the time when the event mode is available to a vehicle may depend on the time zone the vehicle is currently located in. In some embodiments, it may be advantageous to make certain event modes available at the same time across multiple time zones. In response to the current time (e.g., the local time determined by XMM 203) entering the event mode time period, XMM 203 may display a prompt 302 to explore the event or dismiss the event. Interface 300 may be generated for display, by way of processing circuitry 102 and input/output circuitry 110, at an in-vehicle infotainment screen of display 128 (e.g., a heads-up display and/or at one or more dashboard displays depicting graphical user interfaces). In some embodiments, the interface 300 may be generated for a display of mobile device 136 of a user of electric vehicle 101 (e.g., a driver). In response to a user selecting an option to “See What's Spooky” (option 306), interface 400 of FIG. 4 may be displayed. Otherwise, in response to a user selecting an option to “keep things normal” (option 308), the interface returns to normal and the event mode (e.g., the Halloween event mode) is not enabled. In some embodiments, rather than providing one option 306, the XMM 203 may display a plurality of selectable options, corresponding to a plurality of themes.

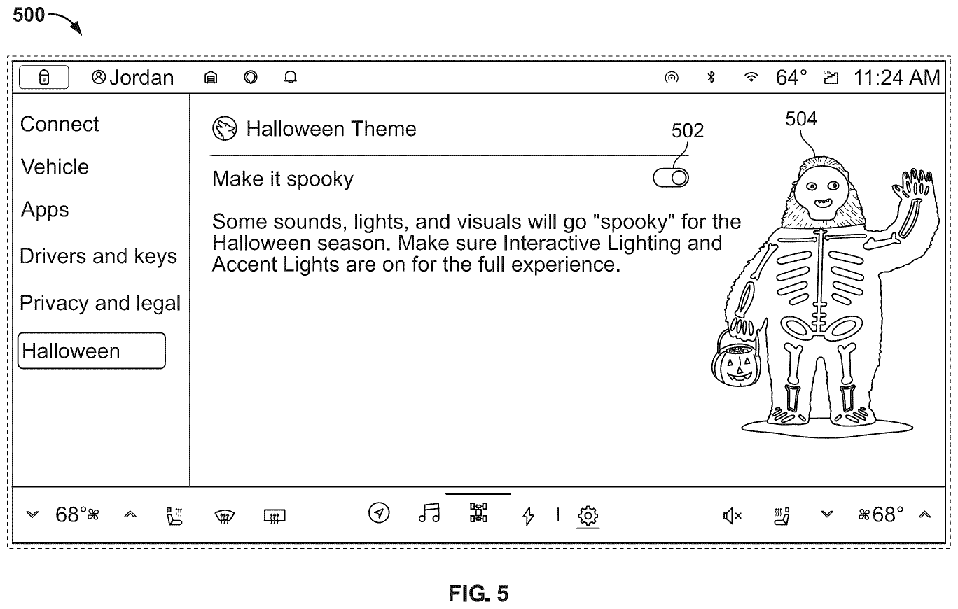

FIG. 4 shows an exemplary interface 400 for enabling the Halloween event mode (e.g., a “Halloween Theme”), in accordance with some embodiments of the present disclosure. As shown, the interface 400 includes a user-selectable option 402 to enable the Halloween event mode. As shown, the Halloween event mode includes a Halloween theme that modifies the normal or default operation of certain sounds, lights, and visuals of vehicle 101, as explained in further detail below. As shown, the interface 400 may display an icon 404 of a Yeti. Interface 400 may also indicate a current user (e.g., user 406) associated with vehicle 101 (e.g., “Jordan”). In some embodiments, the Halloween event mode may be enabled automatically for certain users (e.g., based on the user profile of the user). In response to a user selecting option 402 to enable the Halloween theme, the Halloween event mode is enabled and interface 500 of FIG. 5 may be displayed. Additionally, with reference to FIG. 2, XMM 203 may update an event mode status or vehicle parameters retrieval mode from normal to “Halloween event mode” and send a signal to BCM 205 indicating that the Halloween event mode is active.

FIG. 5 shows an exemplary interface 500 once the Halloween event mode is enabled, in accordance with some embodiments of the present disclosure. As shown, once the Halloween event mode is enabled (502 toggled to enabled), XMM 203 may change the displayed icon 404 of the Yeti to icon 504 of a Halloween-themed Yeti. For example, XMM 203 may update a memory location associated with displaying the icon from a first memory location (e.g., associated with the normal Yeti of FIG. 4) to a second memory location (e.g., associated with the Halloween-themed yet of FIG. 5). Thus, when instructions to display a Yeti are received, XMM 203 may retrieve the Yeti from one of the first or second memory locations, based on the state of the Halloween event mode.

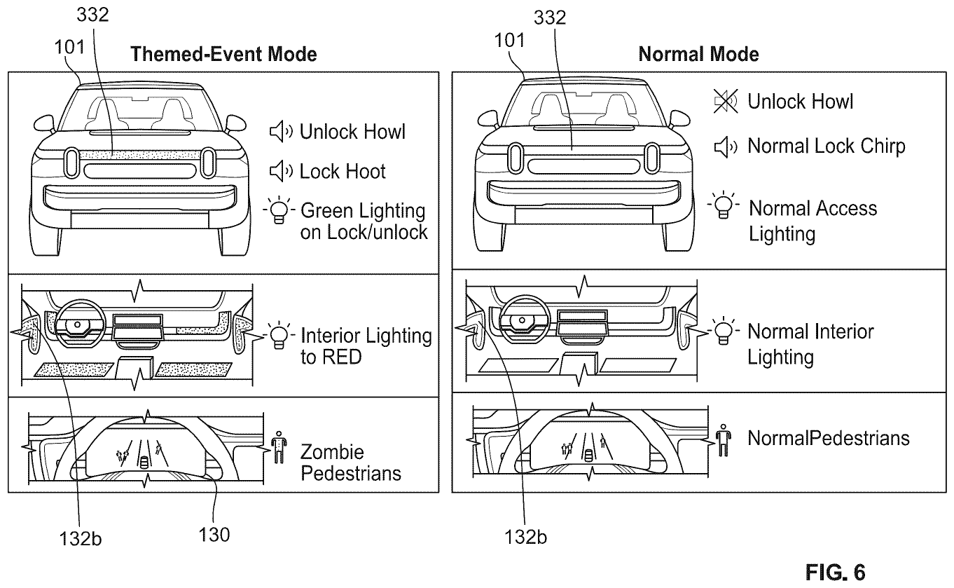

FIG. 6 shows examples of other vehicle functions that are modified when the Halloween event mode is enabled (e.g., as compared with a normal mode), in accordance with some embodiments of the present disclosure. As shown, when the Halloween event mode (e.g., themed-event mode) is enabled, BCM 205 may modify lock/unlock sounds and lighting, as well as the interior lighting of vehicle 101. For example, when an unlock command is received, BCM 205 may retrieve a howl sound (“unlock howl”) from a first location in memory (e.g., memory 106) and control exterior speakers (e.g., speakers 130) to play the sound. In contrast, during a normal mode, BCM 205 may not play any sound when an unlock command is received. Similarly, BCM 205 may retrieve and play a hoot sound (“lock hoot”) when a lock command is received (e.g., instead of a chirp (“lock chirp”) when normal mode is enabled). BCM 205 may also control front light bar 332 of vehicle 101 to display green lighting when either a lock or unlock command is received (e.g., instead of white lighting when normal mode is enabled). In some embodiments, one or more of the event mode features may be synchronized with each other. For example, BCM 205 may control front light bar 332 to display green lighting in an exterior lighting animation that is synchronized with either the unlock howl or the look hoot. For example, the themed lock/unlock sound and front light bar 332 may vary the light intensity (e.g., of the green lighting) in accordance with the sound wave of the themed lock/unlock sound. Additionally, BCM 205 may also control interior lighting 132b of vehicle 101 to display a red color (e.g., instead of white lighting when normal mode is enabled). Of course, these are just examples, and different features of vehicle functions may be provided by different event modes and themes.

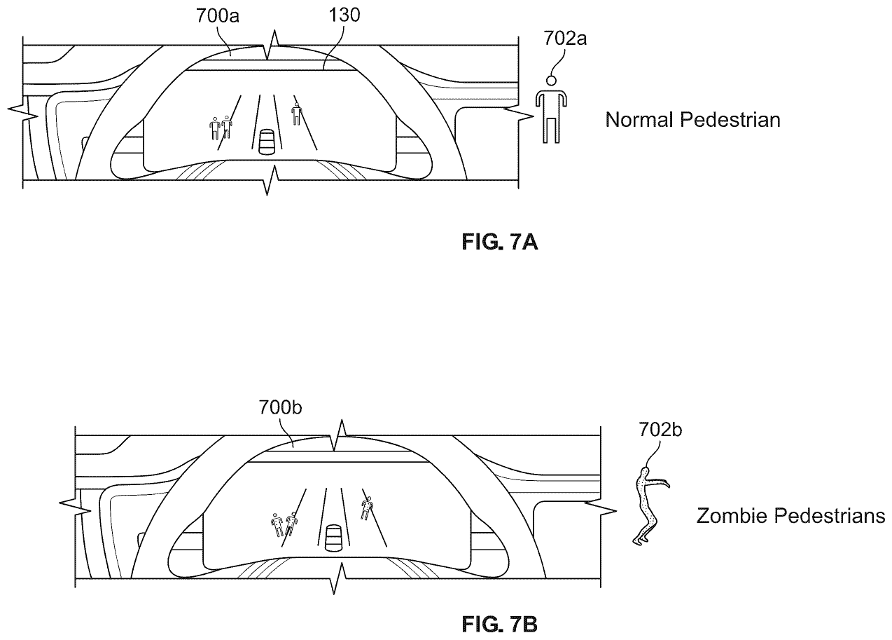

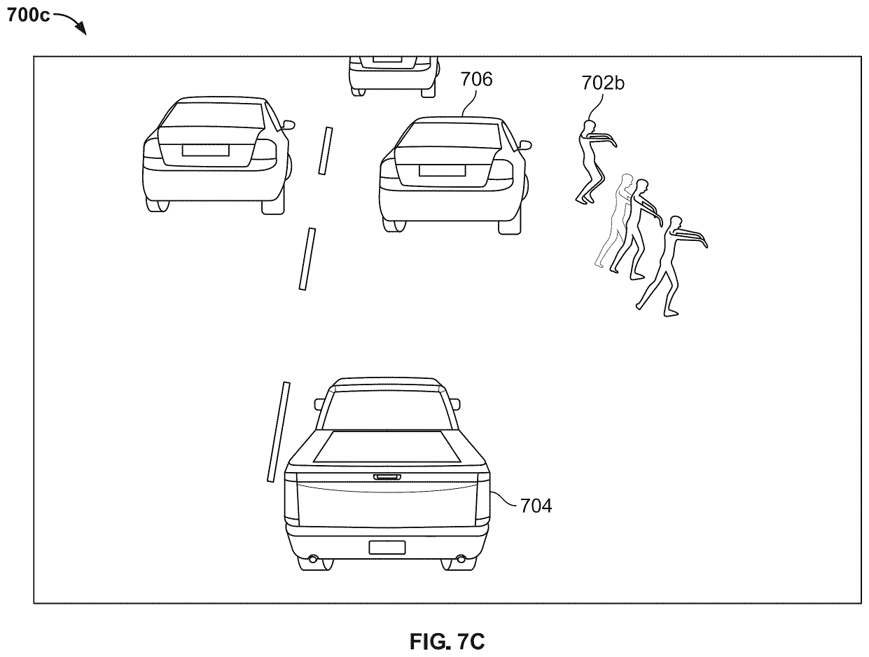

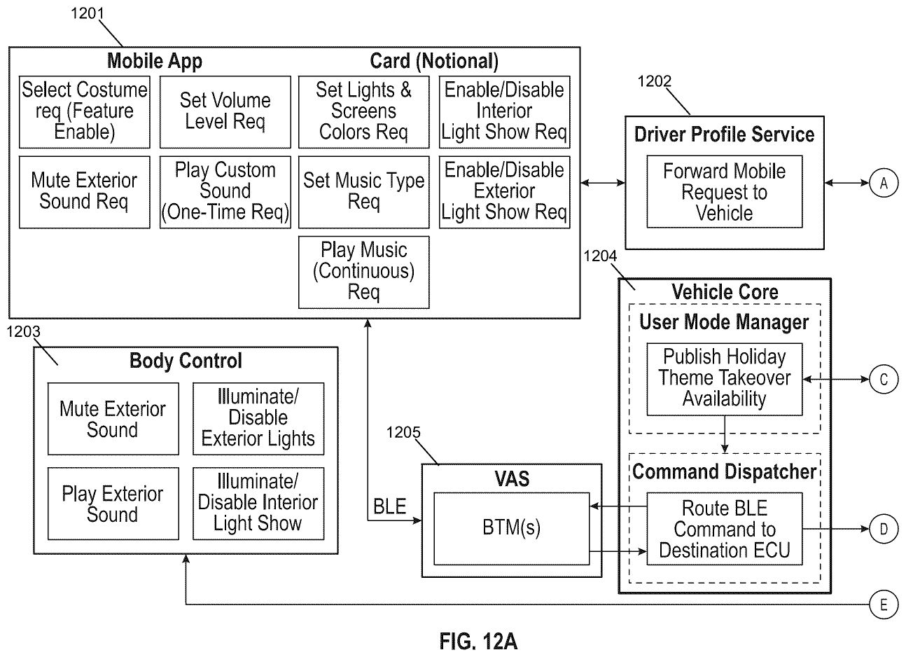

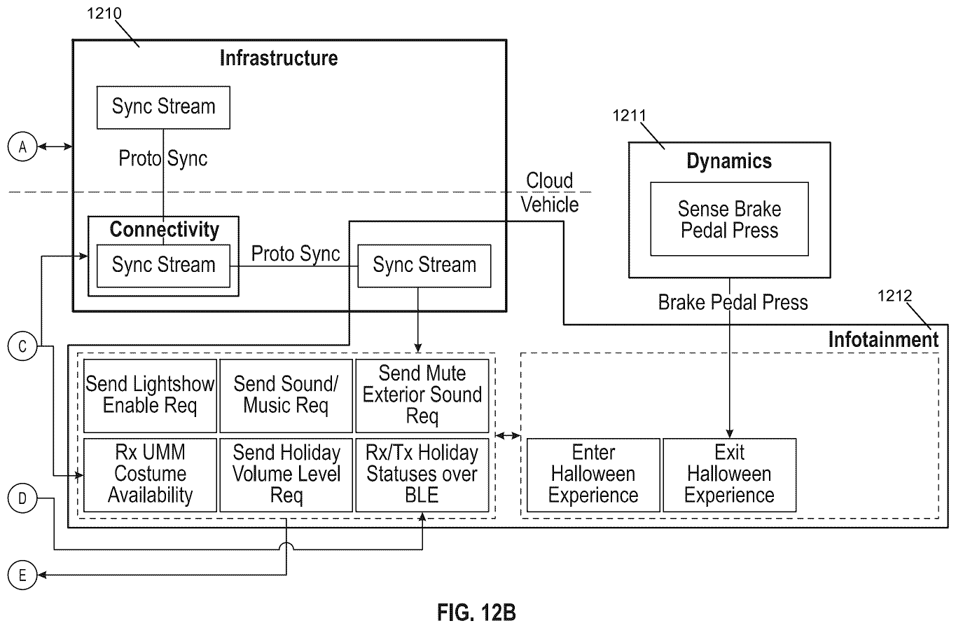

Additionally, when the Halloween event mode is enabled, XMM 203 may display (on display 128) a zombie animation rendering in place of a default rendering of pedestrians captured by sensor 118. In some embodiments, the “zombie pedestrians” may include subtle movements that do not correspond to the actual movements of pedestrians around vehicle 101. For example, although the location and travel of the pedestrians may be accurately rendered, additional zombie-like animations may be included (e.g., dragging a leg, or holding arms up in front of their body). Put another way, as explained in greater detail below with reference to FIGS. 7A-7C, during the Halloween event mode, rendering animations of pedestrians around vehicle 101 on display 128, may be updated by replacing a default pedestrian icon with a zombie pedestrian icon (e.g., by retrieving icons from different locations in memory). Additionally, in some embodiments there may be multiple theme options available for a given event mode. For example, when the Halloween mode is active, there may be multiple different selectable themes, such as a zombie theme, Frankenstein theme, or mummy theme. These embodiments are described in further detail below, particularly with respect to FIGS. 12-19.

FIGS. 7A-7C show examples of a default pedestrian icon and a zombie pedestrian icon that may be displayed during the respective modes, in accordance with some embodiments of the present disclosure. As shown in FIG. 7A, during a normal mode, pedestrians captured by sensor 118 are displayed with default pedestrian icon 702a on interface 700a displayed by display 128. As shown in FIG. 7B, during the Halloween event mode, default pedestrian icon 702a is replaced with zombie pedestrian icon 702b. Thus, pedestrians captured by sensor 118 may be rendered as zombies on interface 700b. FIG. 7C shows another example interface (interface 700c) that is displayed when the Halloween event mode is enabled. FIG. 7C may be a more detailed view of interface 700b of FIG. 7B. As shown, pedestrians captured by sensor 118 may be rendered by zombie pedestrian icon 702b. As detailed above, zombie pedestrian icon 702b may include zombie-like animations. Interface 700c may also display icon 704 representing vehicle 101 and icon 706 representing other vehicles captured by sensor 118.

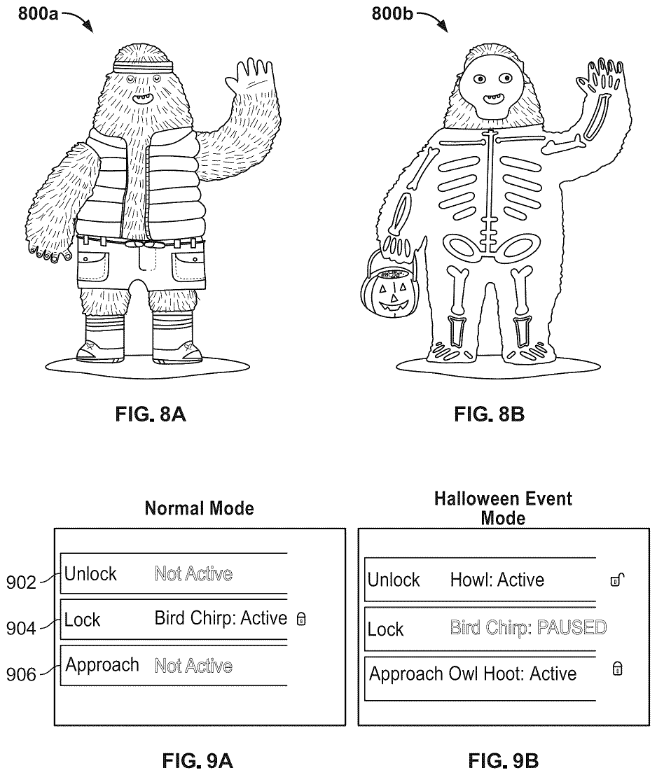

FIGS. 8A and 8B show examples of a default yeti icon and the Halloween yeti icon that may be displayed during the respective modes, in accordance with some embodiments of the present disclosure. As shown in FIG. 8A, during a normal mode, default yeti icon 800a may be displayed. For example, default yeti icon 800a may be displayed as icon 404 on interface 400 shown in FIG. 4. As shown in FIG. 8B, during the Halloween event mode, default yeti icon 800a may be replaced with Halloween yeti icon 800b. For example, Halloween yet icon 800b may be displayed as icon 504 on interface 500 shown in FIG. 5.

FIGS. 9A and 9B show examples of Halloween lock and unlock sounds and of default or normal lock/unlock sounds that may be played during the respective modes, in accordance with some embodiments of the present disclosure. As shown, when the normal mode is active, BCM 205 may be set to not play an unlock sound (e.g., when unlock function 902 is called) or an approach sound when a user is detected approaching vehicle 101 (e.g., when approach function 906 is called). BCM 205 may be set to play a bird chirp when a lock command is received (e.g., when lock function 904 is called) when normal mode is enabled. During normal mode, certain event mode parameters that were enabled during an event mode, but were automatically disabled at the end of the event mode time period, may be enabled by a user through a menu. For example, if a user decides they enjoy the howl sound that is played when the Halloween event mode is enabled, the user may be able to reenable this sound after the Halloween event mode is disabled when the Halloween event mode time period expires and the unlock sound returns to the default of not playing an unlock sound (e.g., if this event mode parameter is made available after the event mode time period). However, other features of the Halloween event mode (e.g., the owl hoot when a user approaches vehicle 101) may be locked and unavailable after the Halloween event mode is disabled.

Although a Halloween event mode is illustrated and described, it should be understood that other event modes with other corresponding event mode periods may be provided. For example, a plurality of different event modes may be stored in memory. In some embodiments, additional event modes and/or themes may be added in advance by an over-the-air (OTA) update. Additionally, it should be understood that certain event modes may be geographically specific or limited or personalized for different users. For example, a birthday event mode may be provided to a user on the day of their birthday (e.g., retrieved from a user profile). In some embodiments, the user profile may be retrieved from a server (e.g., a server associated with the vehicle manufacturer). In a birthday event mode, icons with a birthday theme may be displayed in place of default mode icons. Additionally, in some approaches, a personalized approach sound may be played (e.g., a happy birthday greeting). In another example, a treasure hunt event mode may be provided. In one example, the treasure hunt mode may be automatically enabled when the vehicle reaches a specific secret location during a specific time period. For example, clues to a location may be displayed, and if a user correctly reaches the secret location, special features of vehicle functions may be temporarily unlocked (e.g., lock/unlock sounds, UI display icons, etc.). In another example, a vehicle beta event mode is provided. In this mode, certain trial versions for paid features or functionality of vehicle 101 may be unlocked, without requiring updates or installation of new software (e.g., by an OTA update). In one approach, the vehicle beta event mode may be used to gauge interest in new features or functions. In some embodiments, users may opt in or out of event modes. In some embodiments, because certain features and functionalities may be provided by enabling access to different memory locations during an event mode time period, the number of OTA updates may be reduced, an excessive number of options may be avoided from being displayed on navigation interfaces, and user enjoyment may be improved, without requiring a user to manually update features of vehicle functions during different time periods (e.g., holidays). In some embodiments, one or more vehicle parameters associated with an event mode may be retrieved from a server.

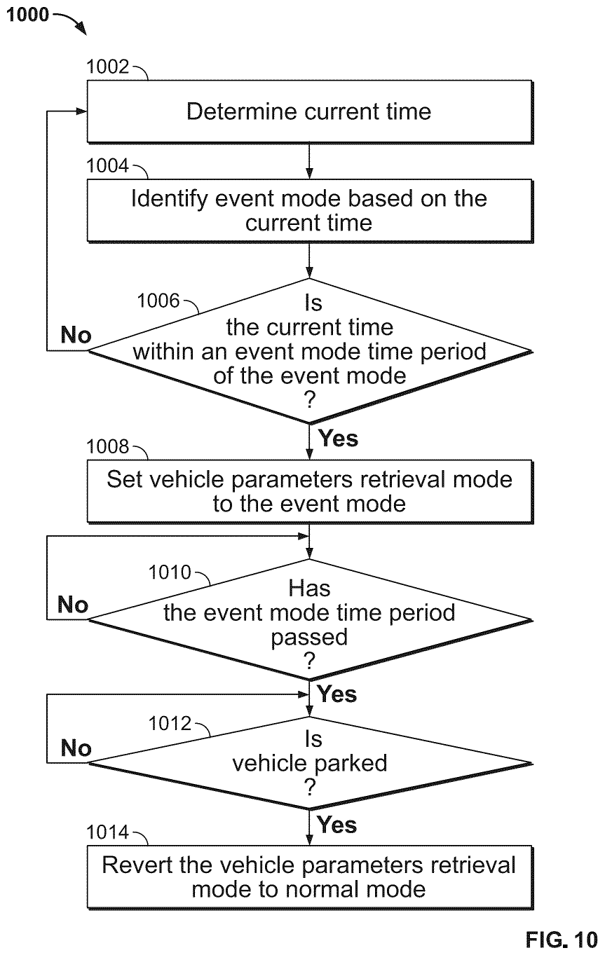

FIG. 10 shows a flowchart of an illustrative process 1000 for enabling an event mode during an event mode time period, in accordance with some embodiments of the present disclosure. Process 1100 may be performed at least in part by processing circuitry 102.

At 1002, processing circuitry 102 determines a current time. For example, processing circuitry 102 determines a current local time based on the location of the vehicle. In one approach, processing circuitry 102 determines the current local time based on an absolute time and the current location.

At 1004, processing circuitry 102 identifies an event mode based on the current time. For example, processing circuitry 102 may search for event mode time periods based on the current time and identify an event mode time period corresponding to the current time. In one approach, multiple event mode time periods (e.g., each associated with different event modes) may be stored in a memory, and a specific event mode may be identified by searching for time periods that include the current time (e.g., or that are approaching based on the current time. In some embodiments, processing circuitry 102 may periodically search for upcoming event mode time periods (e.g., once a day).

At 1006, processing circuitry 102 determines if the current time is within an event mode time period of the identified event mode. For example, processing circuitry 102 may determine if the event mode time period has started by comparing the start time of the event mode time period to the current time (e.g., and the end time). In response to determining that the current time is not within the event mode time period of the identified event mode (“No” at 1006), process 1000 returns to 1002. Otherwise, (“Yes” at 1006), process 1000 proceeds to 1008. In some embodiments, the start and end times of the event mode time period may be used to create activation and deactivation triggers such that when the current time reaches the time of the triggers, the event mode is engaged and disengaged. In some embodiments, the activation and deactivation triggers may be used to prompt a user to enable or disable an event mode time period.

At 1008, processing circuitry 102 sets a vehicle parameters retrieval mode to the event mode. The current vehicle parameters retrieval mode may control the parameters (e.g., settings, sounds, images, etc.), that are retrieved when certain vehicle functions are performed. For example, by setting the vehicle parameters retrieval mode to the events mode, event mode parameters corresponding to the event mode may be retrieved for performing certain vehicle functions (e.g., instead of retrieving normal mode parameters when a normal vehicle parameters retrieval mode is active). In some embodiments, the vehicle parameters for an event mode may change both user-selectable settings (e.g., ambient light color, lock and unlock sounds or visualizations, whether or not unlock or lock sounds are played, etc.) and other vehicle features that are not user selectable (e.g., representations of pedestrians). In some embodiments, as illustrated in FIG. 3, a prompt may be displayed before 1008 and process 1000 only proceeds to 1008 if the user selects the prompt to proceed.

At 1010, processing circuitry 102 determines if the event mode time period has passed. That is, processing circuitry 102 may determine if the current time is still within the event mode time period. In response to determining that the event mode time period has not passed (“No” at 1010), processing circuitry 102 continues to monitor the current time to determine if the current time is still within the event mode time period. Otherwise (“Yes” at 1010), process 1100 proceeds to 1012.

At 1012, processing circuitry 102 determines if the vehicle is parked. In response to determining that the vehicle is not parked (“No” at 1012), processing circuitry 102 continues to monitor vehicle 101. Otherwise (“Yes” at 1012), process 1000 proceeds to 1014. By monitoring whether the vehicle is still traveling when the event mode time period expires (e.g., the current is no longer within the event mode time period, processing circuitry 102 may avoid making any changes to the display or any other vehicle functions that may distract the driver).

At 1014, processing circuitry 102 reverts the vehicle parameters retrieval mode to the normal mode. In some embodiments, processing circuitry 102 may present a screen to a user asking if the user would like to keep one or more of the event mode parameters. In some embodiments, only some of the event mode parameters may be selected (e.g., interior ambient lighting for the event mode may be selectable by a user, but zombie representations of pedestrians may not be selectable).

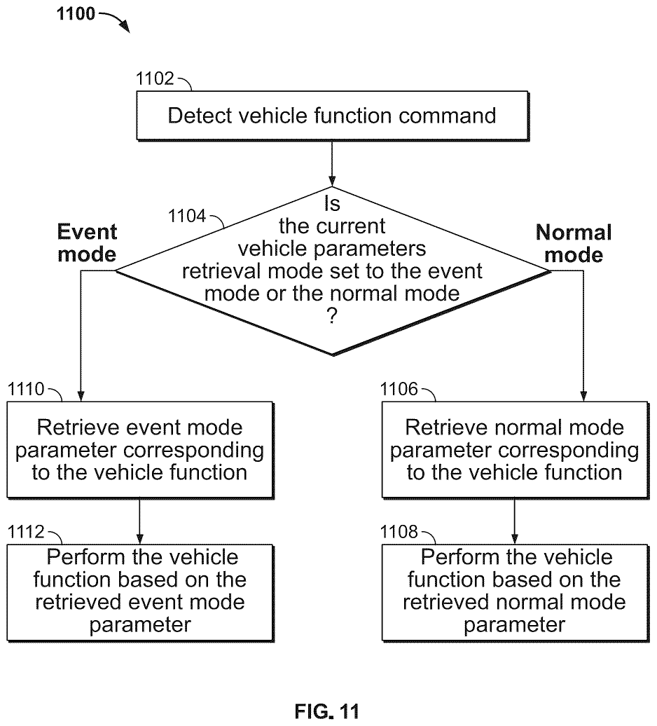

FIG. 11 shows a flowchart of an illustrative process 1100 for performing a vehicle function based on the current vehicle parameters retrieval mode, in accordance with some embodiments of the present disclosure. Process 1100 may be performed at least in part by processing circuitry 102.

At 1102, processing circuitry 102 detects a vehicle function command. For example, processing circuitry 102 may detect a received vehicle function command (e.g., receive a lock/unlock signal), may detect a function call of the vehicle function (e.g., performed automatically by an application, domain controller), or may detect the vehicle function command in any other suitable manner.

At 1104, processing circuitry 102 determines if the current vehicle parameters retrieval mode is set to the event mode (e.g., event operating mode) or the normal mode (e.g., normal operating mode). In response to determining that the current vehicle parameters retrieval mode is set to the normal mode (“Normal Mode” at 1104), process 1100 proceeds to 1106. Otherwise (‘Event Mode”), process 1100 proceeds to 1110.

At 1106, processing circuitry 102 retrieves a normal mode parameter corresponding to the vehicle function. For example, as illustrated in FIG. 6, in response to detecting or receiving a received lock signal (e.g., when the normal mode is active), processing circuitry 102 may retrieve a normal mode sound for locking a door (e.g., a lock “chirp”).

At 1108, processing circuitry 102 may perform the vehicle function based on the retrieved normal mode parameter. For example, in response to retrieving the lock chip, processing circuitry 102 may control a speaker (e.g., speaker 130) to play the retrieved lock chirp.

At 1110, processing circuitry 102 retrieves an event mode parameter corresponding to the vehicle function. In some embodiments, the event mode parameter may be stored in a different memory or memory location than a normal mode parameter (e.g., associated with a normal operating mode where the processor retrieves default instructions or files in order for the vehicle to perform standard vehicle functions or operating characteristics). For example, as illustrated in FIG. 6, in response to detecting or receiving a lock signal (e.g., when the event mode is active), processing circuitry 102 may retrieve an event mode sound for locking the door (e.g., a lock “hoot”) from a second memory location instead of retrieving a normal mode sound (e.g., a lock “chirp”) from a first memory location when the event mode is not active (e.g., a normal operating mode is active). In some embodiments, more than one parameter may be retrieved for performing a vehicle function.

At 1112, processing circuitry 102 may perform the vehicle function based on the retrieved event mode parameter. For example, in response to retrieving the lock hoot, processing circuitry 102 may control a speaker (e.g., speaker 130) to play the retrieved lock hoot. In some embodiments, multiple vehicle functions may be performed for a signal command. For example, in response to receiving a lock command when the event mode is active, processing circuitry 102 may control the speaker to play the retrieved lock hoot and control exterior lighting (e.g., a vehicle light bar) to emit light. In some embodiments, an exterior lighting animation may be synchronized with a lock or unlock sound (e.g., the light intensity may be varied in accordance with the sound wave of the lock or unlock sound).

FIGS. 12A-B illustrate a block diagram of an example system architecture, in accordance with some embodiments of the present disclosure. The system architecture includes a mobile app card 1201, a driver profile service 1202, and an infrastructure block 1210. The system also includes an infotainment block 1212, a body control block 1203, a dynamics block 1211, a vehicle core 1204, and a vehicle access system (VAS) block 1205. The system illustrated in FIG. 12 details some of the features and components of each block, as well as the connections between various blocks over which information is shared.

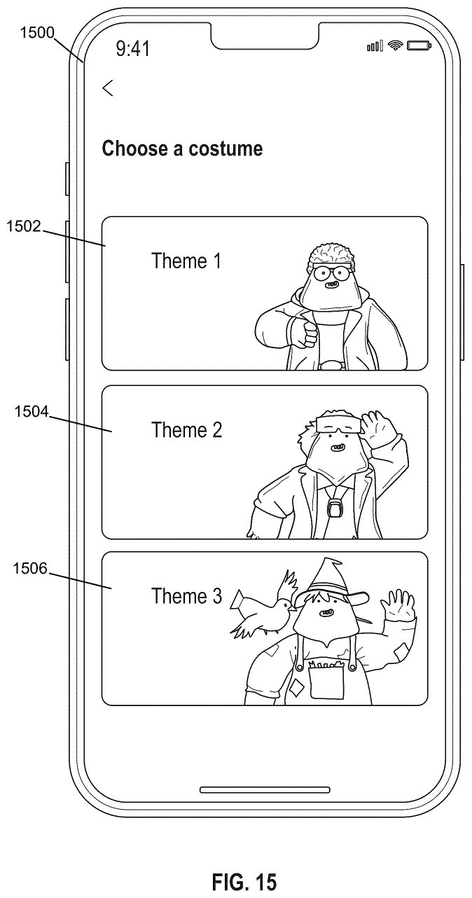

For example, the mobile app card 1201 may operate on a mobile device (e.g., mobile device 136) that is communicatively coupled to the vehicle (e.g., vehicle 101). The mobile device may be configured to present a plurality of selectable options or themes for an event mode. For instance, as illustrated in FIG. 15, the mobile device may present three selectable themes or costumes corresponding to a Halloween event mode.

The mobile device may also be configured to receive user input. The user input may comprise a selection of a desired theme or costume, and/or one or more control inputs. The control inputs may comprise the setting of an exterior or interior volume, exterior or interior lighting levels, setting lighting and display screen colors or themes, setting a music selection or source, playing custom sounds, and enabling or disabling interior or exterior light shows.

The driver profile service 1202 may facilitate communication between the mobile device card 1201 and the vehicle via infrastructure 1210. The drive profile service 1202 may forward relevant communications (e.g., control requests) to the vehicle via infrastructure 1210. Infrastructure 1210 in some embodiments may include a cloud portion (e.g., including server 138) and a vehicle portion, which facilitate communication between the mobile device and the vehicle.

In some embodiments, the mobile device card 1201 also communicates with the VAS 1205 via a Bluetooth connection. The vehicle core 1204 may receive BLE communication from the mobile device and may route the communication to the appropriate ECU(s) of the vehicle.

The infotainment block 1212 may be configured to carry out various functions. For example, the infotainment block 1212 may determine one or more available event mode themes. In some embodiments, the available themes may be based on a current time, current location, user profile data, and/or various other data. The infotainment block 121 may also receive communications from the mobile device via the infrastructure 1210 and the vehicle core 1204. These communications may be intended to control one or more vehicle functions, such as lighting, audio, displays, etc. The infotainment block 1212 may also send commands to the body control block 1203 to control one or more vehicle functions. For example, the commands may include requests to control interior and exterior lighting, requests to control sound and music, status updates, and more. The body control block 1203 may be configured to control the interior and exterior sounds and lighting, as well as various other vehicle features. The infotainment block 1212 may also control when the vehicle enters or exits an event mode, and/or when the event mode is activated or deactivated. The activation or deactivation of the event mode may be automatic, or may be based on a user input.

The dynamics block 1211 may be configured to sense a brake pedal press and/or another drive action. As noted above, in some embodiments when the event mode is active, the user may exit or deactivate the event mode by pressing the brake pedal or taking some other drive action. Upon detecting the drive action, the dynamics module may communicate with the infotainment block 1212, which in turn may disable the event mode and/or may disable one or more event mode functions. In some embodiments, the infotainment system may continue to enable one or more event mode functions even when the event mode is disabled. For instance, if the event mode is disabled in response to the detection of a brake pedal press, the infotainment system may keep a Halloween themed lock sound enabled, even though the Halloween theme is no longer active. This may be done based on user preferences and/or user input selecting to maintain one or more themed functions after the event mode has been disabled.

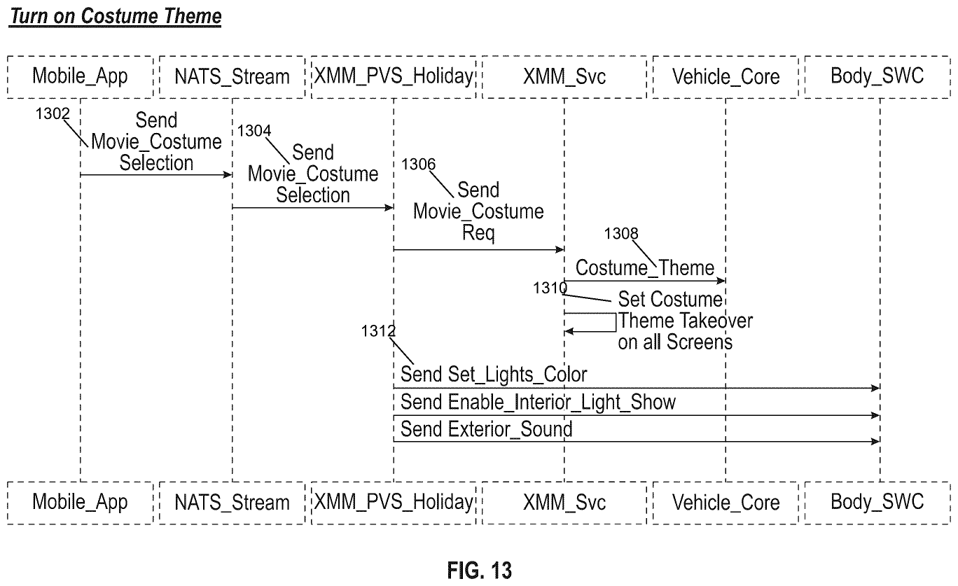

FIG. 13 illustrates a sequence diagram for turning on a costume theme, according to some embodiments of the present disclosure. The sequence diagram illustrates a mobile app block that may correspond to a mobile device, such as device 136 described above. FIG. 13 illustrates various messages and communication between the components of the system. It should be appreciated that in some embodiments, the vehicle must be in park before any costume theme functions or modifications are carried out. That is, the vehicle must be in park before the vehicle lighting, sounds, and other functions or features that comprise the costume theme may be controlled by the mobile application.

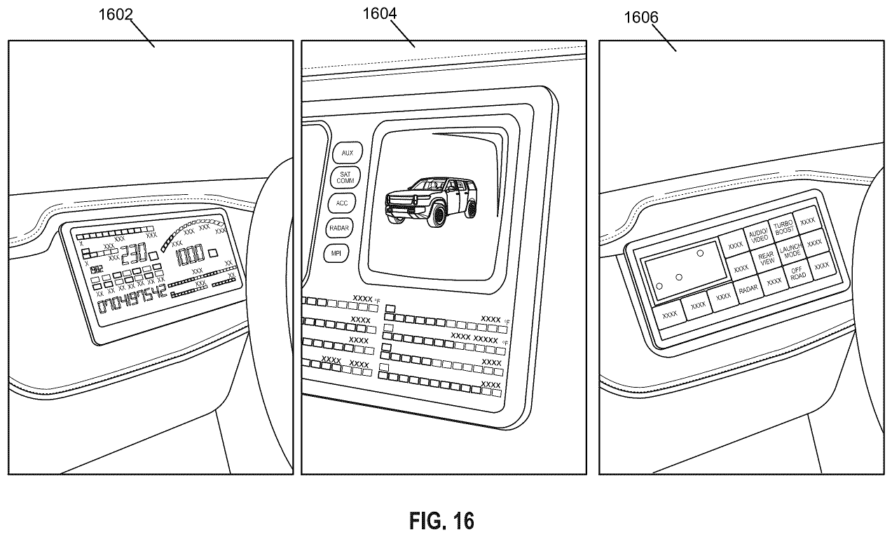

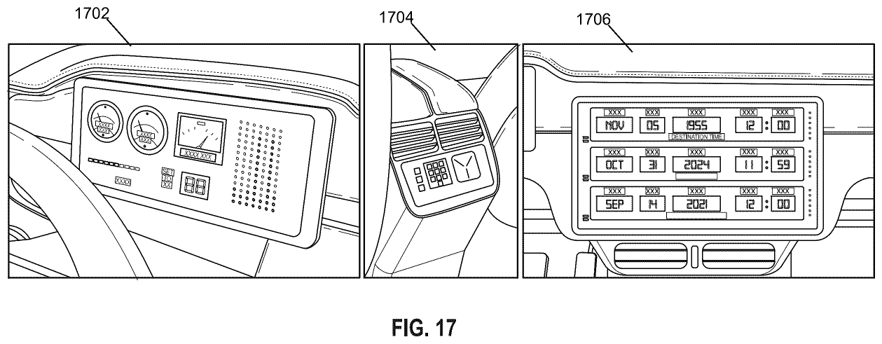

At step 1302, after presenting the plurality of selectable themes for selection by a user via the user interface of the mobile device, the mobile device transmits the selected theme to the NATS (Neural Autonomic Transport System). The NATS is an open-source messaging technology designed for cloud-native distributed systems. At 1304, 1306, and 1308, the NATS passes the selected theme on to the XMM of the vehicle, which passes the selected theme to the vehicle core (e.g., vehicle core 1204 of FIG. 12A). The XMM at step 1310 sets the costume theme takeover on one or more screens of the vehicle. For example, if the selected theme is a scarecrow theme for Halloween, the XMM may change the display theme for one or more of the vehicle displays. Example themed display screens in the vehicle are illustrated in FIGS. 16-17.

At step 1312, the XMM transmits commands to the body control block (e.g., body control block 1203) to control the light color, interior light show, and exterior sound. It should be appreciated that the signals to control light color, interior light show, and exterior sound are illustrated in FIG. 13 for example only. Various other control signals may be used in addition or instead, such as interior lighting, exterior lighting, interior music and audio, exterior music and audio, display screen colors and themes, and more.

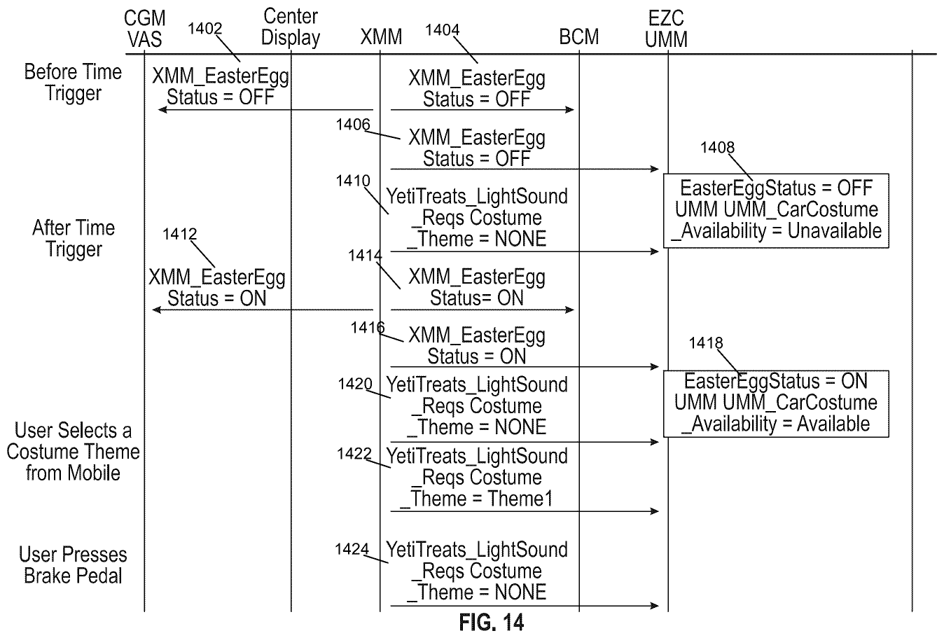

FIG. 14 shows another example sequence diagram showing a selection of relevant signals that are transmitted during various stages of applying a selected theme. The sequence of FIG. 14 illustrates a scenario that begins at a time before a trigger is detected. The trigger may refer to a detection of a particular time, vehicle location, or other data indicating that the event mode is available. Once the trigger is detected, the user may select one of a plurality of presented vehicle themes, which then causes the vehicle to modify one or more vehicle functions (e.g., changing interior/exterior lighting, audio, displays, etc.). Then after a drive action is detected (e.g., a brake pedal press), the vehicle may disable the event mode, and return one or more of the vehicle functions to the original status (e.g., reverting the interior/exterior lighting and/or audio, displays, etc.).

Before a trigger is detected, at step 1402, 1404, and 1406, the XMM of the vehicle provides an event mode status to various components such as the central gateway module (CGM) of the VAS, the body control module (BCM), and the EZC UMM. The event mode status at 1402, 1404, and 1406 is shown as “XMM_EasterEgg Status=OFF” in FIG. 14, indicating that the event mode is not active. At step 1408, the sequence diagram indicates that the event mode is “OFF,” and that the vehicle costume is unavailable. At step 1410, the XMM transmits to the EZC UMM that one or more themes are disabled.

The sequence shown in FIG. 14 may then include detection of a trigger. For example, as described above, the trigger may be a determination that the current time for the vehicle is within a predetermined window (e.g., the current time is 10:00 AM on October 29, within a time window prior to Halloween), that the vehicle is located within a predetermined area, and/or some other trigger. The trigger may indicate that one or more themes are available to the vehicle, and/or that the user is now able to select a theme.

At steps 1412, 1414, and 1416, the XMM provides an event mode status to various components such as the central gateway module (CGM) of the VAS, the body control module (BCM), and the EZC UMM. The event mode status at 1412, 1414, and 1416 is shown as “XMM_EasterEgg Status=ON” in FIG. 14, indicating that the event mode is active. At step 1418, the sequence diagram indicates that the event mode is “ON,” and that the vehicle costume is now available. At step 1420, the XMM transmits to the EZC UMM that there is not yet a selected theme, shown by the signal “YetiTreats_LightSound_Reqs Costume_Theme=NONE.

The user may be presented with a plurality of selectable themes (e.g., as shown in FIG. 15). The selectable themes may be displayed on a mobile device communicatively coupled to the vehicle. After the user selects one of the selectable themes, the XMM may receive the user selection, and may update the status of the selected theme at step 1422. The XMM may change the status indicator from “NONE” to “Theme1” or some other indicator, depending on which theme was selected by the user. The vehicle may then modify one or more vehicle functions based on the selected theme.

While the event mode is active and the selected theme is being used to modify the one or more vehicle functions, the vehicle may be configured to disable or deactivate the selected theme and in some embodiments the event mode based on detecting a drive action. The drive action may include, for example, detecting a brake pedal press, detecting a gear shift, and/or detecting some other user input or vehicle state change. At step 1424. The XMM may, in response to detecting the drive action, set the theme status back to “NONE” to disable the selected theme and/or the event mode.

FIG. 15 illustrates an example mobile device display 1500 enabling the selection of one of a plurality of costume themes 1502, 1504, 1506 for the vehicle. As shown in FIG. 15, the mobile device display 1500 may present a plurality of available vehicle themes 1502, 1504, and 1506, which may be deemed available based on the current time for the vehicle, the current vehicle location, or some other trigger. The mobile device may then receive a selection of one of the available themes 1502, 1504, or 1506. As shown in FIG. 15, the three available themes 1502, 1504, and 1506 all correspond to different costumes for Halloween. It should be appreciated that these themes are shown for illustration only, and that many other themes may be used as well or instead. In some embodiments, there may be one or more themes that are available based on the vehicle location, as well as one or more additional themes that are available based on the current time.

FIG. 16 shows example snapshots of the dashboard display 1602, center console display 1604, and rear seat screen display 1606 for a first costume theme. As shown in FIG. 16, some or all of each of the vehicle displays may be modified to match the selected theme. For example, where the selected theme corresponds to a science fiction theme, the displays may be modified to include one or more science fiction elements or styles. FIG. 17 illustrates a second example dashboard display 1702, rear seat screen display 1704, and center console display 1706, corresponding to a second costume theme. The vehicle may include additional or alternative displays, and it should be appreciated that the selected costume theme may include modifications to any suitable vehicle display, lighting system, sound system, or other output system of the vehicle.

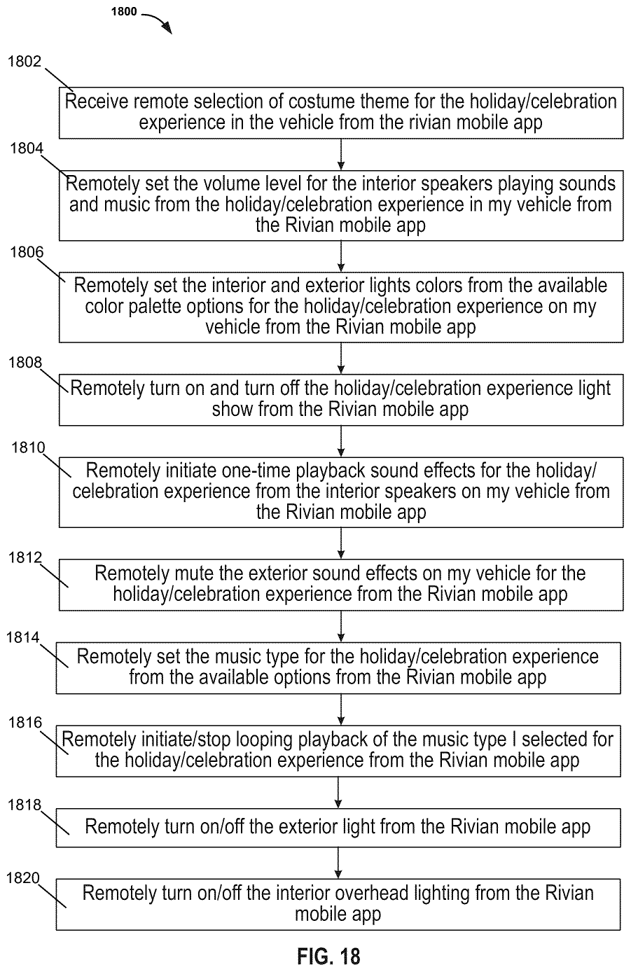

FIG. 18 shows a flowchart of a process 1800 for activating a costume theme via a mobile device, in accordance with some embodiments of the present disclosure. In some embodiments, the vehicle must be parked in order for the functions described herein to be activated. For example, if the vehicle is not in park, the mobile application and/or vehicle may disable selection of a costume theme, and/or may prevent one or more of the functions described herein from being carried out.

At step 1802, the process 1800 includes receiving a remote selection of a costume theme for the holiday or celebration experience in the vehicle from the Rivian mobile app. This selection may be received from a user's mobile device (e.g., device 136), and may include a selection from among a plurality of options as illustrated in FIG. 15. At step 1804, the process 1800 may include remotely setting the volume level for the interior speakers of the vehicle to play sounds and/or music from the selected holiday or celebration experience. The sound may be provided by interior or exterior speakers of the vehicle, which may be controlled by the infotainment system.

At step 1806, the process 1800 may include remotely setting the interior and/or exterior lights of the vehicle to pre-determined colors, selected from the available color palette options for the selected holiday or celebration experience (e.g., selected theme). In some examples, the lighting theme and/or selection may be preset based on the selected theme. Both the volume selection for the music and/or sounds, and the lighting selection for the interior and/or exterior vehicle lights may be selected remotely via the mobile device application. At step 1808, the process 1800 may include enabling the mobile device to remotely turn on and/or off the holiday or celebration experience light show from the mobile application.

At step 1810, the process 1800 may include remotely initiating a one-time playback sound effect for the holiday or celebration experience from the interior vehicle speakers, which may be controlled by the mobile application. There may be multiple different possible sounds that may be used, depending on the selected theme.

At step 1812, the process 1800 may include enabling control of aspects of the vehicle by the mobile application to remotely mute the exterior sound effects on the vehicle for the holiday/celebration experience. Additionally, the process 1800 may include enabling the mobile device application to remotely set the music type for the holiday/celebration experience from the available options from the Rivian mobile app at step 1814. The process 1800 may further include enabling the mobile application to remotely initiate and/or stop looping playback of the music type selected for the holiday/celebration experience at step 1816. At step 1818, the process may further include enabling the mobile application to remotely turn on or off the exterior vehicle lights, and at step 1820 to remotely turn on or off the interior overhead lighting in the vehicle.

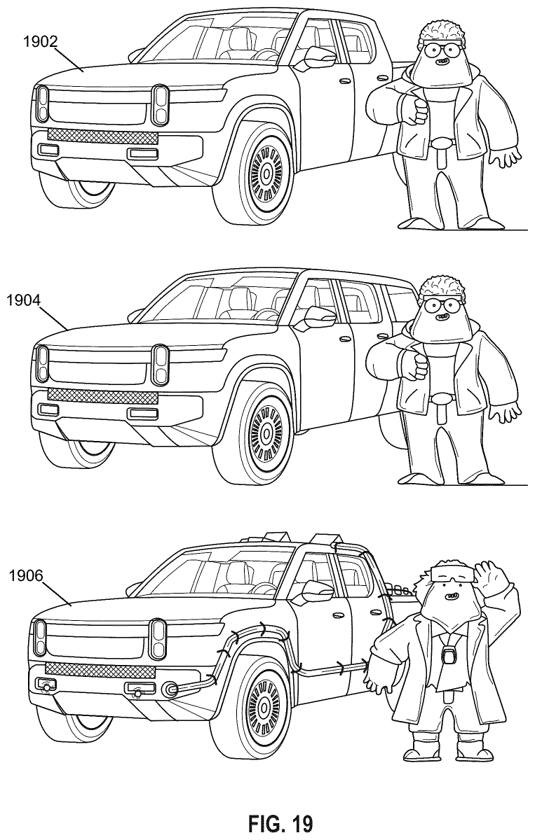

FIG. 19 illustrates example exterior views of various vehicles having active costume themes, in accordance with some embodiments of the present disclosure. For example, vehicle 1902 illustrates a first theme for a first vehicle type. Vehicle 1904 illustrates the first vehicle theme for a second vehicle type. And vehicle 1906 illustrates a second theme for the first vehicle type. These exterior views may, for example, be displayed on a mobile device or on a vehicle display. For example, after a user selects the first theme, the mobile device may display vehicle 1902 to indicate the first them is active on the vehicle.

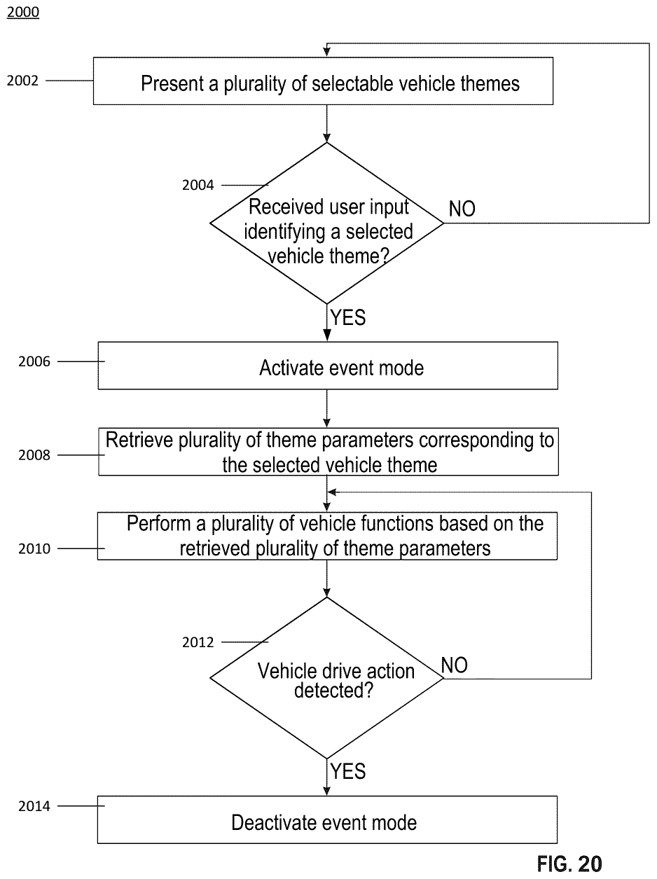

FIG. 20 illustrates an example process 2000 for performing themed vehicle functions, according to embodiments of the present disclosure. In some embodiments, the process 2000 may be performed by processing circuitry, such as any of the processing circuitry or combinations of processing circuitry described herein (e.g., processing circuitry 102, mobile device 138, and/or server 138). At step 2002, the process 2000 includes presenting a plurality of selectable vehicle themes. In some examples, the plurality of selectable vehicle themes may be presented via a mobile device. In other examples, the plurality of selectable vehicle themes may be presented via a display screen of the vehicle (e.g., center console display).

At step 2004, the process 2000 may include determining whether a user input identifying a selected vehicle theme has been received. If no selection was received, the process 2000 may proceed back to step 2002 to continue to present the available vehicle themes.

If a selected theme has been received at step 2004, the process 2000 proceeds to step 2006 at which the vehicle activates the event mode. At step 2008, the vehicle retrieves a plurality of theme parameters corresponding to the selected vehicle theme. These parameters may include interior or exterior lighting colors, patterns, or other features, interior or exterior audio, display modifications, and more.

At step 2010, the process 2000 includes the vehicle performing a plurality of vehicle functions based on the retrieved plurality of theme parameters. For instance, if a theme parameter corresponds to a vehicle horn sound, when the user activates the vehicle horn, the vehicle may retrieve a theme parameter corresponding to the vehicle horn sound (e.g., zombie noise) and may use that themed horn sound instead of a default or normal sound.

At step 2012, the process 2000 includes the vehicle determining whether a vehicle drive action has been detected. As described above, the vehicle drive action may include a brake pedal press, a gear change, or a vehicle state change, for example. If no vehicle drive action is detected at step 2012, the process 2000 proceeds to step 2010 to perform vehicle functions for the selected theme. If, however, at step 2012 the vehicle does detect a vehicle drive action, the process 2000 proceeds to step 2014. At step 2014, the process 2000 includes deactivating the event mode.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

What is claimed is:

1. A method of performing themed vehicle functions for a vehicle, the method comprising:
presenting, via a first user interface, a plurality of selectable vehicle themes;
in response to receiving a user input identifying a selected vehicle theme from the plurality of selectable vehicle themes:
activating an event mode;
retrieving a plurality of theme parameters, wherein the plurality of theme parameters each correspond to the selected vehicle theme; and
performing a plurality of vehicle functions based on the retrieved plurality of theme parameters; and
in response to detecting a vehicle drive action while the event mode is active, deactivating the event mode.

2. The method of claim 1, further comprising:
determining a current time; and
identifying the plurality of selectable vehicle themes based on the current time.

3. The method of claim 1, further comprising:
determining a current vehicle location; and
identifying the plurality of selectable vehicle themes based on the current vehicle location.

4. The method of claim 1, further comprising:
activating the event mode for a predetermined period of time;
in response to determining that the predetermined period of time has ended:
deactivating the event mode;
performing a first vehicle function based at least in part on a first theme parameter of the retrieved plurality of theme parameters; and
performing a second vehicle function based at least in part on a first normal parameter of a retrieved plurality of normal parameters.

5. The method of claim 1, wherein presenting the plurality of selectable vehicle themes is based on determining that the vehicle is parked.

6. The method of claim 1, wherein the first user interface comprises a mobile device communicatively coupled to the vehicle.

7. The method of claim 6, further comprising:
modifying one or more of a volume, interior lighting, exterior lighting, or sound effect of the vehicle based on additional user input to the mobile device.

8. The method of claim 1, wherein detecting the vehicle drive action comprises detecting that the vehicle is no longer parked or detecting a brake pedal input.

9. The method of claim 1, wherein the plurality of vehicle functions comprises at least two of modifying an interior vehicle lighting color, modifying an exterior vehicle lighting color, modifying an interior vehicle audio, modifying an exterior vehicle audio, or modifying a vehicle display screen theme.

10. The method of claim 1, further comprising:
in response to detecting the vehicle drive action while the event mode is active, temporarily deactivating the event mode; and
in response to detecting that the vehicle drive action has ended, re-activating the event mode.

11. A system comprising:
a plurality of devices configured to perform a plurality of vehicle functions of a vehicle; and
processing circuitry configured to:
cause, via a first user interface, a plurality of selectable vehicle themes to be presented;
in response to receiving a first user input identifying a selected vehicle theme from the plurality of selectable vehicle themes:
activate an event mode;
retrieve a plurality of theme parameters, wherein the plurality of theme parameters each correspond to the selected vehicle theme; and
control the plurality of devices to perform the plurality of vehicle functions based on the retrieved plurality of theme parameters; and
in response to detecting a vehicle drive action while the event mode is active, deactivate the event mode.

12. The system of claim 11, wherein the processing circuitry is further configured to:
determine a current time; and
identify the plurality of selectable vehicle themes based on the current time.

13. The system of claim 11, wherein the processing circuitry is further configured to:
determine a current vehicle location; and
identify the plurality of selectable vehicle themes based on the current vehicle location.

14. The system of claim 11, wherein the processing circuitry is further configured to:
activate the event mode for a predetermined period of time;
in response to determining that the predetermined period of time has ended:
deactivate the event mode;
control the plurality of devices to perform a first vehicle function based at least in part on a first theme parameter of the retrieved plurality of theme parameters; and
control the plurality of devices to perform a second vehicle function based at least in part on a first normal parameter of a retrieved plurality of normal parameters.

15. The system of claim 11, wherein the processing circuitry is further configured to:
present the plurality of selectable options based on determining that the vehicle is parked.

16. The system of claim 11, wherein the first user interface comprises a mobile device communicatively coupled to the vehicle.

17. The system of claim 16, wherein the processing circuitry is further configured to:
modify one or more of a volume, interior lighting, exterior lighting, or sound effect of the vehicle based on additional user input to the mobile device.

18. The system of claim 11, wherein the processing circuitry is configured to detect the vehicle drive action by detecting that the vehicle is no longer parked or detecting a brake pedal input.

19. The system of claim 11, wherein the plurality of vehicle functions comprises at least two of modifying an interior vehicle lighting color, modifying an exterior vehicle lighting color, modifying an interior vehicle audio, modifying an exterior vehicle audio, or modifying a vehicle display screen theme.

20. The system of claim 11, wherein the processing circuitry is further configured to:
in response to detecting the vehicle drive action while the event mode is active, temporarily deactivate the event mode; and
in response to detecting that the vehicle drive action has ended, re-activate the event mode.
